(19) United States
(12) Patent Application Publication
(10) Pub. No.: US 2007/0036060 A1
(43) Pub. Date: Feb. 15, 2007

(54) DATA RECORDING METHOD, DATA REPRODUCING METHOD, DATA RECORDING APPARATUS, DATA REPRODUCING APPARATUS, AND INFORMATION RECORDING MEDIUM

(75) Inventor: Kenji Shirasuna, Tokyo (JP)

Correspondence Address: GREENBLUM & BERNSTEIN, P.L.C., 1950 ROLAND CLARKE PLACE, RESTON, VA, 20191, US

(73) Assignee: TDK Corporation, Tokyo (JP)

(21) Appl. No.: 11/463,631

(22) Filed: Aug. 10, 2006

(30) Foreign Application Priority Data
Aug. 11, 2005 (JP) 2005/232886
Nov. 28, 2005 (JP) 2005/341985

(51) Int. Cl. G11B 9/00

(52) U.S. Cl. 369/126

(57) ABSTRACT

A data recording method that records data by carrying out a mark forming process that blows recording mark forming gas onto a surface of an information recording medium substrate and irradiates first recording positions on the surface set corresponding to a content of the data to be recorded using a recording mark forming beam to cause recording material included in the recording mark forming gas to accumulate at regions irradiated with the recording mark forming beam and form recording marks, which have a different electrical resistance to the surface of the information recording medium substrate, at the first recording positions.

### BACKGROUND OF THE INVENTION

1. Field of the Invention

The present invention relates to a data recording method and data recording apparatus that record data by forming recording marks at positions set corresponding to a data content, an information recording medium on which data has been recorded in accordance with the recording method, and a data reproducing method and data reproducing apparatus that reproduce data from the information recording medium.

2. Description of the Related Art

As one example of this type of data recording method and data reproducing method, a recording/reproducing method that uses a scanning probe is disclosed in Japanese Laid-Open Patent Publication No. H09-17047. This recording/reproducing method uses a disk that has lands in the shape of concentric circles formed on one surface and an AFM (Atomic Force Microscope) probe head (hereinafter simply “probe”) whose front tip is coated with gold. When recording data, a plurality of gold dots are formed at predetermined intervals in accordance with the data content on information tracks set on the lands of the disk. More specifically, when the probe has moved to a predetermined position set in accordance with the data content, gold on the probe surface is transferred onto the disk by field evaporation to form a gold dot. By doing so, as one example, a plurality of gold dots with a diameter of 50 nm are formed on an information track at intervals of 125 nm. On the other hand, when reproducing the data, the disk is rotated in a state where the front tip of the probe contacts a land (i.e., an information track) of the disk and concaves and convexes on the information track are detected via the cantilever of the probe. On a disk where data has been recorded in accordance with the recording method described above, positions where the gold dots have been formed protrude from the land surface. Accordingly, the formation positions of gold dots can be specified on the information track by specifying the positions of convexes that protrude from the land surface, and therefore the data can be reproduced based on the position information of such specified gold dots.

### SUMMARY OF THE INVENTION

However, by investigating the conventional recording/reproducing method (and apparatus), the present inventor found the following problem. With the conventional recording/reproducing method, data is recorded by forming gold dots (recording marks) by transferring gold from the probe tip to the disk by field evaporation. This means that when data has been recorded in accordance with the conventional recording method, the amount of gold coating the probe tip becomes depleted by the amount used by the recording marks formed on the disk. Accordingly, when a large number of recording marks are formed to record a large amount of data, it becomes necessary to regularly replace the probe before all of the gold on the probe tip is used up. This means that the conventional recording method has a problem in that a complex probe replacement operation has to be carried out when recording a large amount of data.

Also, in the conventional recording/reproducing method, convexes that protrude from the land surface are detected by rotating the disk in a state where the probe tip is in contact with a land and data is reproduced based on position information for the positions where convexes are detected. To avoid having convexes and concaves in the land surface cause convexes to be erroneously detected at positions where no recording marks have actually been formed (i.e., to avoid reproduction errors), it is necessary to fabricate the disk so that the surfaces of the lands (i.e., the information tracks) are sufficiently smooth. Accordingly, with the conventional recording/reproducing method, there is the problem that it is difficult to reduce the manufacturing cost of information recording media. When data is recorded with a higher density, the size of the recording marks formed to record data also becomes smaller, which means that small concaves and convexes in the lard surface cause reproduction errors.

In addition, with the conventional recording/reproducing method, since data is recorded in binary according to the presence or absence of a gold dot (i.e., the presence or absence of a convex), to record data at a much higher density, the formation pitch of the recording marks formed on the disk (i.e., the distance between adjacent recording marks on the disk) has to be made even narrower and the size of the recording marks has to be made even smaller. When data that has been recorded at a higher density is reproduced, it is difficult to correctly detect the presence or absence of such small recording marks that are formed with a narrow pitch, leading to the risk of reproduction errors occurring. In this way, with the conventional recording/reproducing method, there is the problem that it is difficult to record data at an even higher density.

The present invention was conceived in view of the problems described above and it is a principal object of the present invention to provide a data recording method and data recording apparatus that can easily record a large amount of data, an information recording medium on which data has been recorded in accordance with such recording method, and a data reproducing method and data reproducing apparatus that can reduce the manufacturing cost of the information recording medium without causing reproduction errors. It is a further object of the present invention to provide a data recording method and data recording apparatus that can record a large amount of data with a high density, an information recording medium on which data has been recorded in accordance with such recording method, and a data reproducing method and data reproducing apparatus that can reproduce data from such information recording medium without causing reproduction errors.

To achieve the stated object, a data recording method according to the present invention records data by carrying out a mark forming process that blows recording mark forming gas onto a surface of an information recording medium substrate and irradiates first recording positions on the surface set corresponding to a content of the data to be recorded using a recording mark forming beam to cause recording material included in the recording mark forming gas to accumulate at regions irradiated with the recording mark forming beam and form recording marks, which have a different electrical resistance to the surface of the information recording medium substrate, at the first recording positions. Note that the expression “the content of the data” used in this specification refers to information that has been digitized (i.e., encoded) using binary (ones and zeros) for example. Accordingly, if the code for the letter “A” in the data is recorded in binary using ISO sevenbit codes, for example, (that is, if the letter “A” is recorded using the bit string “1001000”), if recording marks are formed corresponding to the ones in the bit string, the “first recording positions” for the present invention correspond to the first position and fourth position out of seven consecutive positions on the surface of the information recording medium substrate.

A data recording apparatus according to the present invention records data and includes: a gas blowing unit that blows recording mark forming gas onto a surface of an information recording medium substrate; a beam irradiating unit that irradiates the information recording medium substrate with a recording mark forming beam; and a control unit that controls the gas blowing unit and the beam irradiating unit, wherein the control unit controls the gas blowing unit to blow the recording mark forming gas onto the surface and, at first recording positions on the surface set corresponding to the content of the data to be recorded, controls the beam irradiating unit to emit the recording mark forming beam to cause recording material in the recording mark forming gas to accumulate at regions irradiated with the recording mark forming beam to form recording marks, which have a different electrical resistance to the surface of the information recording medium substrate, at the first recording positions.

According to the data recording method and data recording apparatus described above, by recording data by forming recording marks, which have a different electrical resistance to the surface of the information recording medium substrate, by blowing the recording mark forming gas onto the surface of the information recording medium substrate and emitting the recording mark forming beam to cause the recording material to accumulate at the irradiated regions, unlike the conventional recording/reproducing method that forms gold dots (recording marks) by transferring gold from the probe Lip to the disk, by housing the gas producing material for producing the recording mark forming gas in the gas blowing unit in the data recording apparatus, it is possible to continuously form a large number of recording marks without replacing recording components (such as the probe used in the conventional recording method) during the data recording process. Accordingly, a large amount of data can be recorded easily.

A data reproducing method according to the present invention reproduces data from an information recording medium on which data has been recorded in accordance with the data recording method described above, wherein by applying a voltage between a predetermined position on the information recording medium substrate and a position on the surface that differs to the predetermined position and measuring the current that flows between the predetermined position and the position on the surface, the data recorded on the information recording medium substrate is reproduced based on the current measured at each position.

A data reproducing apparatus according to the present invention is constructed to reproduce data from an information recording medium on which data has been recorded in accordance with the data recording method described above, the data reproducing apparatus including: a voltage applying unit that applies a voltage between a predetermined position on the information recording medium substrate and a position on the surface that differs to the predetermined position; a current measuring unit that measures the current that flows between the predetermined position and the position on the surface; and a control unit that controls the voltage applying unit and the current measuring unit, wherein the control unit controls the voltage applying unit to apply the voltage and controls the current measuring unit to measure the current and reproduces the data based on the current measured at each position on the surface.

According to the data reproducing method and data reproducing apparatus described above, when reproducing the data from an information recording medium on which data has been recorded in accordance with the data recording method described above, the data is reproduced based on a current measured when a voltage is applied between the predetermined position on the information recording medium substrate and a position on the surface that differs to the predetermined position. By doing so, unlike the conventional recording/reproducing method that detects the concaves and convexes on a land and reproduces data based on position information of positions where convexes are detected, even if concaves and convexes of a certain size are present on the data recording surface of the information recording medium substrate, it will still be possible to avoid having recording marks erroneously detected. Since it is not necessary to make the surface (the data recording surface) of the information recording medium substrate extremely smooth, it is possible to sufficiently reduce the manufacturing cost of the information recording medium and to properly reproduce data while avoiding data reproduction errors.

The data recording method according to the present invention may record the data on the information recording medium substrate by executing a concave forming process that forms concaves at second recording positions on the surface set corresponding to the content of the data to be recorded and the mark forming process.

Another data recording apparatus according to the present invention includes: a beam irradiating unit that irradiates one surface of an information recording medium substrate with a recording beam; a gas blowing unit that blows recording mark forming gas onto the surface; and a control unit that controls the beam irradiating unit and the gas blowing unit, wherein the control unit records data on the information recording medium substrate by carrying out: a concave forming process where the control unit controls the beam irradiating unit to irradiate second recording positions, which are set corresponding to the content of the data to be recorded out of a plurality of recording positions on the surface, with the recording beam whose power has been set greater than a predetermined power to form concaves at the second recording positions; and a mark forming process where the control unit controls the gas blowing unit to blow the recording mark forming gas onto the surface and, at first recording positions set corresponding to the content of the data to be recorded out of the recording positions, controls the beam irradiating unit to emit the recording beam with a power that is no greater than the predetermined power to cause recording material in the recording mark forming gas to accumulate and form recording marks, which have a different electrical resistance to the surface, at the first recording positions.

According to the data recording method and data recording apparatus described above, by recording data on the information recording medium substrate by carrying out a concave forming process that forms concaves at the second recording positions set corresponding to the content of the data to be recorded and a mark forming process that forms recording marks, which have a different electrical resistance to the surface, at the first recording positions, it is possible to record data as multivalue data on the information recording medium substrate using combinations of the presence/absence of a concave and the presence/absence of a recording mark at each recording position. Unlike the conventional recording/reproducing method that records data according to the presence/absence of only recording marks (gold dots), it is possible to sufficiently raise the recording density of the data that can be recorded per unit area of the information recording medium substrate without forming the concaves and the recording marks with a narrow pitch causing the risk of reproduction errors.

Another data reproducing method according to the present invention reproduces data from an information recording medium on which data has been recorded in accordance with the data recording method described above, wherein by executing a distance measuring process that measures a distance from a reference plane at each position on the surface of the information recording medium substrate and executing a current measuring process that applies a voltage between each position or the surface and a predetermined position on the information recording medium substrate that differs to the position on the surface and measures the current that flows between the position on the surface and the predetermined position, the data recorded on the information recording medium is reproduced based on the distance measured at each position by the distance measuring process and the current measured at each position by the current measuring process.

Another data reproducing apparatus according to the present invention is constructed to reproduce data from an information recording medium where data has been recorded on an information recording medium substrate in accordance with the data recording method described above, the data reproducing apparatus including: a distance measuring unit that measures the distance from a reference plane at each position on the surface of the information recording medium substrate; a current measuring unit that applies a voltage between each position on the surface and a predetermined position on the information recording medium substrate that differs to the position on the surface and measures the current that flows between the predetermined position and the position on the surface; and a control unit that controls the distance measuring unit and the current measuring unit, wherein the control unit controls the distance measuring unit to carry out a distance measuring process to measure the distance from the reference plane at each position on the surface, controls the current measuring unit to carry out a current measuring process to measure the current at each position on the surface, and reproduces the data based on the distance and the current measured at each position.

According to the data reproducing method and data reproducing apparatus described above, when reproducing data from an information recording medium on which data has been recorded by the data recording method described above, a distance measuring process that measures the distance from a reference plane at each position on the surface of the information recording medium substrate and a current measuring process that applies a voltage between each position on the surface and a predetermined position on the information recording medium substrate that differs to the position on the surface and measures the current that flows between the predetermined position and the position on the surface are carried out to reproduce the data based on the distance measured at each position by the distance measuring process and the current measured at each position by the current measuring process. By doing so, the data can be properly and correctly read from an information recording medium on which data has been recorded as multivalue data using combinations of the presence/absence of a concave and the distance from a reference plane and the presence/absence of a recording mark and the current at each recording position.

With the data recording method according to the present invention, the recording marks may be formed at the first recording positions with electrical resistances that correspond to the content of the data to be recorded.

According to the data recording method described above, by forming recording marks with electrical resistances that correspond to the content of the data, compared to a data recording method that records data by forming one type of recording marks (binary recording based on the presence/absence of recording marks), it is possible to record the data on the information recording medium substrate with a density that is increased by an amount corresponding to the ability to record multivalue data in accordance with the types of recording marks.

With the data recording method according to the present invention, in the concave forming process, the concaves may be formed at the second recording positions with depths that correspond to the content of the data to be recorded.

According to the data recording method described above, by forming concaves with depths that correspond to the content of the data at the second recording positions during the concave forming process, compared to a data recording method that records the data by forming one type of concaves (a method where the data is recorded using combinations of the presence/absence of concaves and the presence/absence of recording marks), it is possible to record the data on the information recording medium substrate with a density that is increased by an amount corresponding to the ability to record multivalue data in accordance with the types of concaves.

With the data recording method according to the present invention, a plurality of types of recording marks with respectively different electrical resistances may be formed on the surface by adjusting the amount of irradiation with the recording mark forming beam at each first recording position where the recording marks are to be formed to change the thickness of the recording material that accumulates on the surface in accordance with the content of the data.

According to the data recording method described above, by forming a plurality of types of recording marks with respectively different electrical resistances on the surface of the information recording medium substrate by adjusting the amount of irradiation with the recording mark forming bean to change the thickness of the recording material that accumulates on the surface in accordance with the content of the data, it is possible to reliably form the recording marks with the desired heights (i.e., recording marks with the desired electrical resistances) at the recording positions with a comparatively simple construction.

With the data recording method according to the present invention, a plurality of types of recording marks may be formed with respectively different electrical resistances by using one out of a plurality of types of recording mark forming gases that include different types of recording material.

According to the data recording method described above, by forming a plurality of types of recording marks with different electrical resistances by setting one type out of a plurality of types of recording mark forming gases with different types of recording materials, it is possible to record the data as multivalue data by forming recording marks of the desired electrical resistances without greatly varying the height of the recording marks at different recording positions.

With the data recording method according to the present invention, a plurality of types of concaves with respectively different depths may be formed by adjusting the amount of irradiation with the recording beam.

According to the data recording method described above, by forming a plurality of types of concaves with different depths by adjusting the amount of irradiation with the recording beam, it is possible to reliably form concaves with the desired depths at recording positions with a comparatively simple construction.

With the data recording method according to the present invention, during the concave forming process, the concaves may be formed by irradiating the second recording positions with the recording beam with a power that exceeds a predetermined power, and during the mark forming process, the recording marks may be formed by irradiating the first recording positions with the recording beam with a power that is no greater than the predetermined power.

According to the data recording method described above, by forming the concaves during the concave forming process by irradiating the second recording positions with the recording beam with a power that exceeds a predetermined power, and forming the recording marks during the mark forming process by irradiating the first recording positions with the recording beam with a power that is no greater than the predetermined power, it is possible to form concaves at the desired recording positions with high precision using a comparatively simple construction.

An information recording medium according to the present invention has data recorded thereupon by forming recording marks at the first recording positions in accordance with the data recording method described above.

According to the information recording medium described above, since data is recorded by forming the recording marks at the first recording positions according to the data recording method described above, unlike the conventional recording/reproducing method that forms gold dots recording marks) by transferring gold from the probe tip to the disk, It is possible to sufficiently reduce the manufacturing cost of an information recording medium on which data has been recorded.

On an information recording medium according to the present invention, data may be recorded by forming concaves at second recording positions on the surface set corresponding to the content of the data and forming recording marks at the first recording positions.

According to the information recording medium described above, by recording data by forming the concaves at the second recording positions set corresponding to the content of the data and forming the recording marks, which have different electrical resistances to the surface of the information recording medium substrate, at the first recording positions set corresponding to the content of the data, it is possible to record the data using multivalue data based on combinations of the presence/absence of a concave and the presence/absence of a recording mark at each recording position. Therefore, unlike an information recording medium on which data has been recorded according to the conventional recording/reproducing method that records data based on the presence/absence of recording marks (gold dots) only, it is possible to provide an information recording medium on which the data has been recorded with a sufficiently high recording density per unit area of the information recording medium substrate.

On an information recording medium according to the present invention, the recording marks may be formed with electrical resistances that correspond to the content of the data.

According to the information recording medium described above, by forming the recording marks with electrical resistances that correspond to the content of the data, compared to an information recording medium where the data has been recorded by forming one type of recording marks (an information recording medium on which the data has been recorded in binary based on the presence/absence of recording marks), it is possible to provide an information recording medium on which the data has been recorded with a recording density per unit area of the information recording medium substrate that is increased by an amount corresponding to the ability to record multivalue data in accordance with the types of recording marks.

On an information recording medium according to the present invention, the concaves may be formed with depths that correspond to the content of the data.

According to the information recording medium described above, by forming the concaves with depths that correspond to the content of the data, compared to an information recording medium where the data has been recorded by forming one type of concaves (an information recording medium on which the data has been recorded based on combinations of the presence/absence of concaves and the presence/absence of recording marks), it is possible to provide an information recording medium on which the data has been recorded with a recording density per unit area of the information recording medium substrate that is increased by an amount corresponding to the ability to record multivalue data in accordance with the types of concaves.

It should be noted that the disclosure of the present invention relates to a content of Japanese Patent Application 2005-232886 that was filed on 11 Aug. 2005 and a content of Japanese Patent Application 2005-341985 that was filed on 28 Nov. 2005, the entire contents of which are herein incorporated by reference.

### BRIEF DESCRIPTION OF THE DRAWINGS

These and other objects and features of the present invention will be explained in more detail below with reference to the attached drawings, wherein:

FIG. 1 is a block diagram showing the construction of a data recording apparatus;

FIG. 2 is a plan view of an information recording medium on which recording marks have been formed;

FIG. 3 is a cross-sectional view of the information recording medium on which recording marks have been formed;

FIG. 4 is a block diagram showing the construction of a data reproducing apparatus;

FIG. 5 is another plan view of the information recording medium on which recording marks have been formed;

FIG. 6 is a plan view of an information recording medium on which concaves and recording marks have been formed;

FIG. 7 is a cross-sectional view of an information recording medium on which concaves have been formed;

FIG. 8 is a cross-sectional view of an information recording medium on which recording marks have been formed;

FIG. 9 is a cross-sectional view of a stamper;

FIG. 10 is a cross-sectional view of a substrate on which a resist layer has been formed;

FIG. 11 is a cross-sectional view of the substrate in a state where the convex/concave pattern of the stamper has been pressed onto the resist layer;

FIG. 12 is a cross-sectional view of the substrate in a state where the stamper has been separated from the resist layer in the state shown in FIG. 11;

FIG. 13 is a cross-sectional view of the substrate in a state where an etching process has been carried out with the convex/concave pattern shown in FIG. 12 as a mask;

FIG. 14 is a cross-sectional view of an information recording medium where recording marks have been formed at recording positions on the substrate shown in FIG. 13.

FIG. 15 is a plan view of another information recording medium in a state where concaves and recording marks have been formed.

### DESCRIPTION OF TEE PREFERRED EMBODIMENTS

Preferred embodiments of a data recording method, a data reproducing method, a data recording apparatus, a data reproducing apparatus, and an information recording medium according to the present invention will now be described with reference to the attached drawings.

### First Embodiment

A first embodiment of a data recording method, a data recording apparatus and an information recording medium according to the present invention will be described first with reference to the drawings.

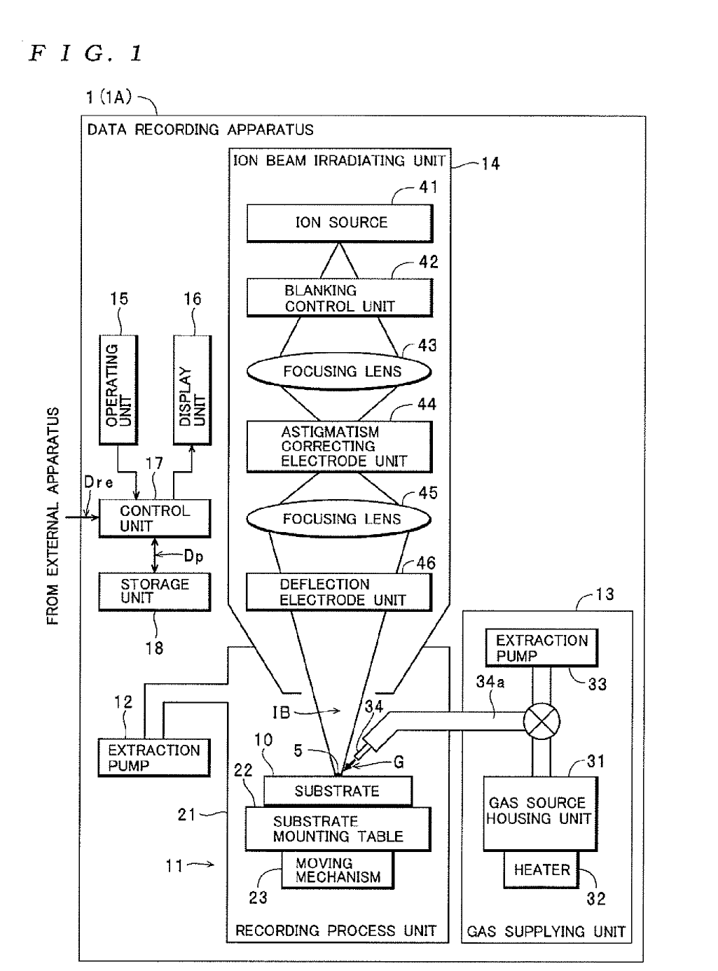

A data recording apparatus 1 shown in FIG. 1 is an apparatus for recording data in accordance with the data recording method according to the present invention, and as one example is connected to an external apparatus such as a personal computer and is constructed so as to be capable of recording data Dre outputted from the external apparatus onto a substrate 10 (information recording medium 3). The substrate 10 corresponds to an “information recording medium substrate” for the present invention, and as one example is composed of a silicon plate where a data recording surface onto which data is to be recorded has been smoothed. Note that the information recording medium substrate for the present invention is not limited to a silicon plate like the substrate 10, and includes a plate made of various materials such as metal materials, resin materials, glass, and ceramics. The information recording medium substrate is not limited to a plate-like form, and includes a tape-like or film-like substrate with sufficiently reduced thickness.

On the other hand, the data recording apparatus 1 includes a recording process unit 11, an extraction pump 12, a gas supplying unit 13, an ion beam irradiating unit 14, an operating unit 15, a display unit 16, a control unit 17, and a storage unit 18. The recording process unit 11 includes a vacuum case 21, a substrate mounting table 22, and a moving mechanism 23. The vacuum case 21 is constructed so as to be capable of housing the substrate mounting table 22, the moving mechanism 23, and the substrate 10, and the periphery of the substrate 10 is kept in a vacuum state by evacuating the air inside the vacuum case 21 using the extraction pump 12. The substrate mounting table 22 is formed so that the substrate 10 can be mounted thereupon. The moving mechanism 23 moves the substrate mounting table 22 along a mounting surface (the upper surface in FIG. 1) of the substrate mounting table 22 according to control by the control unit 17 to move the substrate 10 on the substrate mounting table 22. The extraction pump 12 evacuates the air inside the vacuum case 21 according to control by the control unit 17.

The gas supplying unit 13 corresponds to a “gas blowing unit” for the present invention and includes a gas source housing unit 31, a heater 32, an extraction pump 33, and a nozzle 34. The gas source housing unit 31 houses a gas-producing material for producing “recording mark forming gas” for the present invention (as one example, an organic metal material such as hexacarbonyl tungsten or an aromatic hydrocarbon such as phenanthrene). In accordance with control by the control unit 17, the heater 32 heats the gas-producing material via the gas source housing unit 31 to cause evaporation or sublimation and thereby produces the recording mark forming gas inside the gas source housing unit 31. Here, when hexacarbonyl tungsten or phenanthrene is used as the gas-producing material, a hydrocarbon gas G is produced as the recording mark forming gas. Note that in the present specification, an example where hydrocarbon gas G is produced as the recording mark forming gas using phenanthrene is described. The extraction pump 33 supplies the hydrocarbon gas G produced inside the gas source housing unit 31 to the nozzle 34 via a pipe 34a. The nozzle 34 is disposed inside the vacuum case 21 and blows out the hydrocarbon gas G supplied by the extraction pump 33 toward the substrate 10 on the substrate mounting table 22.

The ion beam irradiating unit 14 corresponds to a “beam irradiating unit” for the present invention, includes an ion source 41, a blanking control unit 42, focusing lenses 43, 45, an astigmatism correcting electrode unit 44, and a deflection electrode unit 46, and is constructed so as to be able to emit an ion beam IB of various powers (i.e., beam intensities) toward the substrate 10 on the substrate mounting table 22 according to control by the control unit 17. The ion source (i.e., the ion generating unit) 41 generates ions (for example, gallium ions) at a front end of an emitter by applying a predetermined electric field between the emitter front end and an extraction electrode (not shown) in a state where liquid metal (for example, gallium) has been supplied to the front end of a metal emitter (not shown) and causing the ions to accelerate toward the extraction electrode so that the ion beam IB (one example of a “recording mark forming beam” for the present invention) is outputted from the extraction electrode. Note that in place of gallium, it is possible to use various types of liquid metals such as gold, gold clusters, or bismuth. According to control by the control unit 17, the blanking control unit 42 carries out blanking control (on/off control) of the ion beam IB outputted from the ion source 41. The focusing lenses (beam shaping lenses) 43, 45 shape (i.e., reduce the diameter of) the ion beam IB. The astigmatism correcting electrode unit 44 shapes the ion beam IB so that the beam spot is shaped as a perfect circle. The deflection electrode unit 46 deflects the ion beam IS shaped by the focusing lens 45 according to control by the control unit 17 to change the irradiated position of the substrate 10.

The operating unit 15 includes a plurality of operation switches (not shown) for making setting operations relating to the operating state of the data recording apparatus 1. The display unit 16 displays information relating to the progress of a recording process, various types of error information, and the like. The control unit 17 carries out overall control over the various components of the data recording apparatus 1 to form recording marks 5, which correspond to the content of the data Dre outputted from the external apparatus, on the substrate 10 (i.e., the control unit 17 carries out the data recording method according to the present invention). The storage unit 18 stores recording procedure data Dp in which the recording procedure that relates to the data recording process has been recorded.

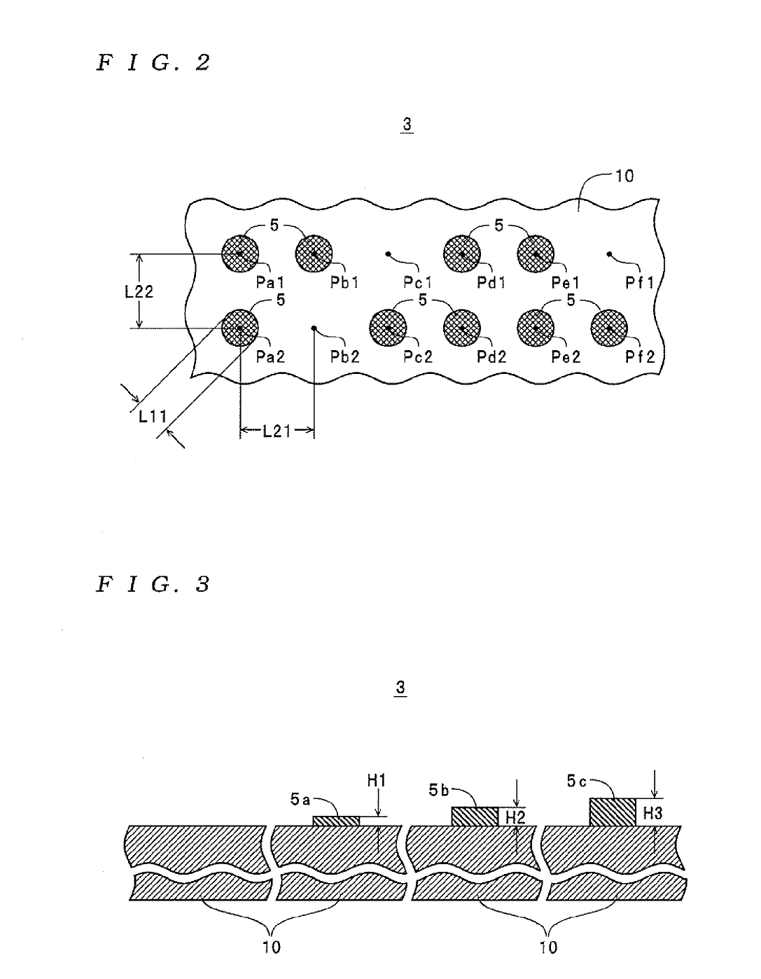

As shown in FIG. 2, in the data recording apparatus 1, the recording data Dre is recorded by forming the recording marks 5 corresponding to the content of the recording data Dre at recording positions, Pa1, Pb1, . . . Pa2, Pb2, . . . (hereinafter simply referred to as “recording positions P” when no distinction is required) set in a grid on the substrate 10 with a density of 8×10¹⁰ positions per square inch, for example. Note that in the following description, the substrate 10 on which the recording marks 5 have been recorded is also referred to as the “information recording medium 3”. If adjacent recording marks 5 on the substrate 10 are too far apart, the number of recording marks 5 that can be formed per unit area on the substrate 10 will fall, making it impossible to record the data Dre at high density. Accordingly, to achieve high-density recording, adjacent recording marks 5 on the substrate 10 should preferably be as close together as possible. More specifically, if the diameter L11 of the recording marks 5 is set at 100 nm, as one example, the center-to-center distances L21, L22 between adjacent recording positions P should preferably be set at 200 nm or below (200% or less of the diameter L11 of the recording marks 5).

On the other hand, if the adjacent recording marks 5 are formed too close together on the substrate 10 so that the adjacent recording marks 5 overlap each other, it will be difficult to distinguish individual recording marks 5 during reproduction of the data Dre. Accordingly, to avoid having adjacent recording marks 5 being formed in an overlapping state on the substrate 10, it is necessary to set the center-to-center distances L21, L22 of the adjacent recording positions P sufficiently wider than the diameter L11 of the recording marks 5. More specifically, if the diameter L11 of the recording marks 5 is set at 100 nm, as one example, the center-to-center distances L21, L22 of the adjacent recording positions 2 should preferably be set at 110 nm or above (i.e., at least 110% of the diameter L11 of the recording marks 5). In this example, the center-to-center distances L21, L22 of the adjacent recording positions P are set at 150 nm. Note that in FIG. 2, for ease of understanding the present invention, the center-to-center distances L21, L22 of the recording positions P have been exaggerated.

Also, as shown in FIG. 3, on the data recording apparatus 1, by forming three types of recording marks 5a to 5c with different heights (i.e., thicknesses) at the recording positions P in accordance with the content of the data Dre, the data Dre is recorded as multivalue data. As one example, the recording marks 5a are formed so that the height H1 thereof is in a range of 1 nm to 3 nm inclusive (for example, 2 nm), the recording marks 5b are formed so that the height H2 thereof is in a range of 4 nm to 6 nm inclusive (for example, 5 nm), and the recording marks 5c are formed so that the height H3 thereof is in a range of 11 nm to 13 nm inclusive (for example, 12 nm). By doing so, the electrical resistance of the recording marks 5a to 5c will differ due to the differences in the heights (thicknesses) H.

When recording the data Dre using the data recording apparatus 1, first, the substrate 10 is set on the substrate mounting table 22 with the data recording surface facing upward. Next, the control unit 17 controls the extraction pump 12 to evacuate the air inside the vacuum case 21 and controls the heater 32 to heat the phenanthrene inside the gas source housing unit 31 to produce the hydrocarbon gas G inside the gas source housing unit 31. After this, when the data Dre has been outputted from the external apparatus, the control unit 17 controls the extraction pump 33 to supply the hydrocarbon gas G from the gas source housing unit 31 via the pipe 34a to the nozzle 34 and controls the moving mechanism 23 to move the substrate mounting table 22 so that a recording position Pa1, for example, on the substrate 10 is positioned below the ion beam irradiating unit 14. Next, based on the data Dre and the recording procedure data Dp stored in the storage unit 18, the control unit 17 controls the ion beam irradiating unit 14 to irradiate the recording position Pa1 (one example of a “first recording position” for the present invention) on the substrate 10 with the ion beam IB.

When doing so, secondary electrons are generated from the substrate 10 by the ion beam IB emitted toward the recording position Pa1 and the hydrocarbon gas G blown out from the nozzle 34 toward the substrate 10 is separated into a gas component and a solid component (carbon) by the influence of the secondary electrons. The separated gas component is evacuated by the extraction pump 12 from the vacuum case 21 and the carbon that is the solid component accumulates on the substrate 10 (at the recording position Pa1). By doing so, as shown in FIG. 2, a recording mark 5 that is an accumulation of carbon is formed at the recording position Pa1 (i.e., the recording mark 5 is formed by vapor-phase growth). When doing so, the blanking control unit 42 adjusts the irradiation time for which the substrate 10 is irradiated with the ion beam IB in accordance with control by the control unit 17 and thereby changes the amount of carbon that accumulates on the substrate 10 to form one out of the recording marks 5a to 5c with the different heights H1 to H3 (the “mark forming process” for the present invention). After this, the control unit 17 controls the deflection electrode unit 46 of the ion beam irradiating unit 14 to change the irradiated position of the ion beam IB to the recording position Pb1 on the substrate 10 which is then irradiated. By doing so, a recording mark 5 is formed at the recording position Pb1. Next, in accordance with the content of the data Dre, the control unit 17 forms a recording mark 5 at the recording position Pd1 without forming a recording mark 5 at the recording position Pd1.

When forming a recording mark 5 at a recording position P outside the range in which the ion beam IB can be deflected by the deflection electrode unit 46, the control unit 17 controls the moving mechanism 23 to move the substrate mounting table 22 so that the recording position P is positioned below the ion beam irradiating unit 14. In addition, when the formation of the recording marks 5 on the first row (the recording positions Pa1, Pb1) out of the recording positions P set in a grid has been completed, the control unit 17 controls the moving mechanism 23 to move the substrate mounting table 22 so that the recording position Pa2 that is in the first column out of the second row of the recording positions P on the substrate 10 is positioned under the ion beam irradiating unit 14 and controls the ion beam irradiating unit 14 to emit the ion beam IB to form a recording mark 5 at the recording position Pa2. In this way, by successively forming the recording marks 5 at the recording positions P (“first recording positions” for the present invention) on the substrate 10 in accordance with the content of the data Dre, one series of data recording processes is completed.

In this way, according to the data recording method that uses the data recording apparatus 1, the control unit 17 controls the gas supplying unit 13 to blow out the hydrocarbon gas G from the nozzle 34 onto one surface of the substrate 10 and controls the ion beam irradiating unit 14 to emit the ion beam IB and thereby cause carbon to accumulate at regions irradiated with the ion beam IB to form recording marks 5, which have different electrical resistances to the surface of the substrate 10, thereby recording the data Dre. By doing so, unlike the conventional recording/reproducing method that forms gold dots (i.e., recording marks) by transferring gold from the probe tip to the disk, by housing a gas producing material (in this example, phenanthrene) for producing the hydrocarbon gas G in the gas supplying unit 13 (the gas source housing unit 31), it is possible to continuously form a large number of recording marks 5 without replacing recording components (such as the probe used in the conventional recording method) during the data recording process. Accordingly, a large amount of recording data can be recorded easily.

Also, according to the data recording method that uses the data recording apparatus 1, by forming the recording marks 5a to 5c with electrical resistances that correspond to the content of the data, compared to a data recording method that records the data Dre by forming one type of recording marks 5 (binary recording based on the presence/absence of recording marks 5), it is possible to record the data Dre with a density that is increased by an amount corresponding to the ability to record multivalue data in accordance with the types of recording marks 5.

Also, according to the data recording method that uses the data recording apparatus 1, by adjusting the amount of irradiation with the ion beam IB to change the thickness of the carbon accumulated on the surface in accordance with the content of the data Dre, a plurality of types of recording marks 5a to 5c with respectively different electrical resistances are formed on the surface of the substrate 10. By doing so, compared to a data recording method that records the data Dre by forming one type of recording marks 5 (binary recording based on the presence/absence of recording marks 5), it is possible to record the data Dre on the substrate 10 with a density that is increased by an amount corresponding to the ability to record multivalue data in accordance with the types of recording marks 5.

Also, according to the information recording medium 3 on which the data Dre has been recorded according to the data recording method described above, unlike the conventional recording/reproducing method that forms gold dots (recording marks) by transferring gold from the probe tip to the disk, it is possible to sufficiently reduce the manufacturing cost of an information recording medium 3 on which the data Dre has been recorded.

Also, according to the information recording medium 3 on which the data Dre has been recorded according to the data recording method described above, compared to an information recording medium 3 where the data Dre has been recorded by forming one type of recording marks 5 (an information recording medium 3 on which the data Dre has been recorded based on the presence/absence of recording marks 5), it is possible to provide an information recording medium 3 on which the data Dre has been recorded with a recording density per unit area of the substrate 1.0 that is increased by an amount corresponding to the ability to record multivalue data in accordance with the types of recording marks 5.

Note that the invention corresponding to this first embodiment is act limited to the construction or method described above. For example, although the recording marks 5 are formed by the data recording apparatus 1 described above by irradiating the substrate 10 with the ion beam IB during the data recording process, it is possible to use a construction that forms the recording marks 5 by accumulating a recording material on the substrate 10 by irradiation with various types of charged particle beam, such as an electron beam, in place of the ion beam IB. Also, although the data recording apparatus 1 is constructed so that the blanking control unit 42 adjusts the irradiation time of the ion beam IB to change the amount of radiation and thereby form recording marks 5a to 5c with the different heights H1 to H3, it is possible to use a construction where the beam intensity of the ion beam IB outputted from the ion beam irradiating unit 14 is adjusted to change the amount of irradiation with the ion beam IB and thereby form the recording marks 5a to 5c with the different heights H1 to H3.

The number of types of recording marks 5 is not limited to three, and it is possible to use a construction where the data Dre is recorded as multivalue data by forming two or more types of recording marks 5. When doing so, if the diameter L11 of the recording marks 5 is set at 100 nm and the data Dre is recorded as multivalue data using three types of recording marks 5a to 5c as in the example described above, data can be recorded at a high density of around 240 Gbit per square inch. With the same conditions, if the data Dre is recorded as multivalue data using two hundred types of recording marks 5, data can he recorded at a high density of around 16 Tbit per square inch. Conversely, when multivalue recording is not carried out, data can be recorded at a high density of around 80 Gbit per square inch.

It is also possible to use a construction where the data Dre is recorded by forming one type of recording marks 5 with the same height H across the entire substrate 10 (i.e., binary recording). The method of changing the electrical resistance of the recording marks 5 formed at the recording positions P is not limited to the data recording method described above that changes the height (thickness) H of the carbon accumulated on the substrate 10. For example, it is possible to use a method that forms recording marks 5 composed of solid components with different electrical resistances on the substrate 10. To do so, a construction is used that can blow out two or more types of recording mark forming gases, where the electrical resistance of the solid component that will be separated by irradiation with the ion beam IB differs, onto the substrate 10 and the recording mark forming bean is emitted while blowing one of the recording mark forming gases in accordance with the content of the data Dre.

Next, a first embodiment of a data reproducing method and data reproducing apparatus according to the present invention will be described with reference to the drawings.

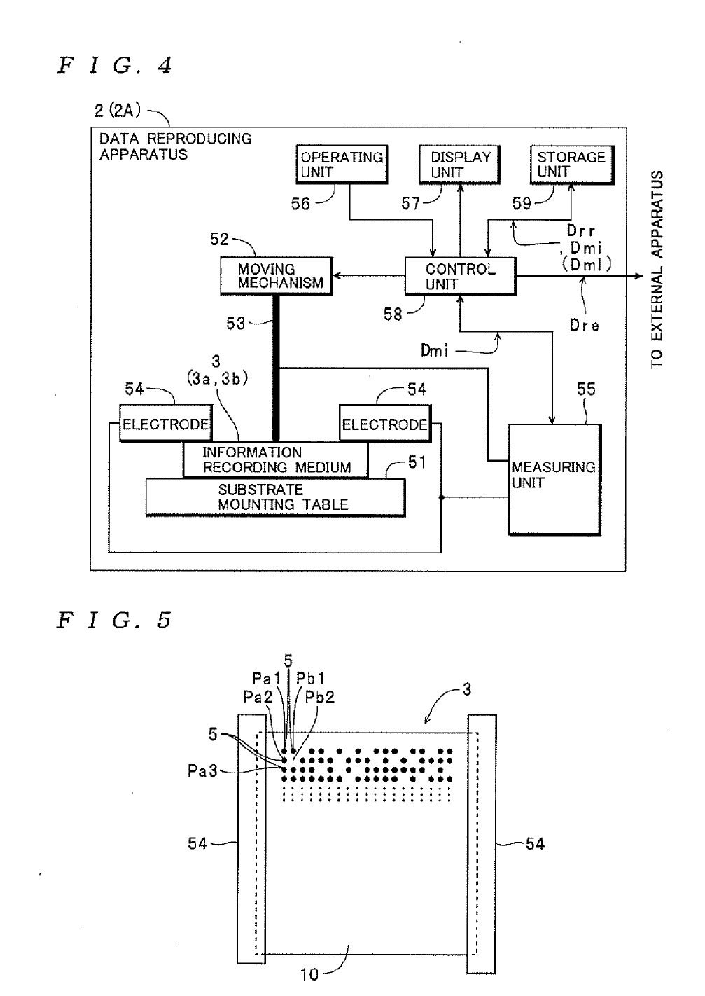

A data reproducing apparatus 2 shown in FIG. 4 is an apparatus for reproducing (reading) data in accordance with the data reproducing method according to the present invention, and as one example, is connected to an external apparatus such as a personal computer and constructed so as to be capable of reproducing (i.e., reading) data Dre from the information recording medium 3 (the substrate 10 on which the recording marks 5 have been formed) on which data Dre has been recorded by the data recording apparatus 1 described above and outputting the data to the external apparatus. The data reproducing apparatus 2 Includes a substrate mounting table 51, a moving mechanism 52, a probe 53, electrodes 54, a measuring unit 55, an operating unit 56, a display unit 57, a control unit 58, and a storage unit 59.

The substrate mounting table 51 is formed so that the information recording medium 3 can be mounted thereupon In accordance with control by the control unit 58, the moving mechanism 52 moves the probe 53 along the data recording surface of the information recording medium 3 on the substrate mounting table 51. The probe 53 is a contact probe, has a base end that is fixed to the moving mechanism 52, and is electrically connected to the measuring unit 55 via a signal cable. In the data reproducing apparatus 2, as one example, a single crystal silicon probe that has a tip with a radius of curvature of around 10 nm and whose surface has been covered with PtIr so as to become conductive is used as the probe 53. The electrodes 54 are formed in plate-like shapes using a conductive material such as aluminum, for example, and are electrically connected to the measuring unit 55 via signal cables. As shown in FIG. 5, the electrodes 54 are disposed so as to be electrically connected to both ends that face each other (“predetermined positions” for the present invention) of the substrate 10 of the information recording medium 3. The measuring unit 55 corresponds to a “voltage applying unit” and a “current measuring unit” for the present invention and in accordance with control by the control unit 58, applies a voltage of around 1.5V between the probe 53 and the electrodes 54, measures the current flowing between the probe 53 and the electrodes 54, and outputs measurement data Dmi for the measurement results to the control unit 58.

The operating unit 56 includes a plurality of operation switches (not shown) for making setting operations relating to the operating state of the data reproducing apparatus 2. The display unit 57 displays information relating to the progress of a reproduction process, various types of error information, and the like. The control unit 58 carries out overall control over the various components of the data reproducing apparatus 2 and reproduces (i.e., reads) the data Dre from the information recording medium 3 based on the current (measurement data Dmi) measured at every position (the recording positions P described above) on the information recording medium 3 by the measuring unit 55 (i.e., the control unit 58 carries out the data reproducing method according to the present invention). The control unit 58 outputs the reproduced data Dre to the external apparatus. The storage unit 59 stores reproduction reference data Drr for reproducing the data Dre based on the current measured by the measuring unit 55 and the measurement data Dmi outputted from the measuring unit 55.

When reproducing the data Dre using the data reproducing apparatus 2, first the information recording medium 3 is set on the substrate mounting table 51 with the data recording surface facing upward, and the electrodes 54 are disposed at both ends of the substrate 10. Next, when a predetermined operation button of the operating unit 56 has been operated to designate a start of reproduction of the data Dre, the control unit 58 controls the moving mechanism 52 to move the probe 53 to contact the recording position Pa1 on the substrate 10. Next, the control unit 58 controls the measuring unit 55 to start measuring the current. When doing so, the measuring unit 55 measures, via the probe 53 and the electrodes 54, the current that flows between one end of the substrate 10 (the position contacted by the electrodes 54: “a predetermined position” for the present invention) and the recording position Pa1 (a position contacted by the probe 53: “a position on the surface” for the present invention).

A recording mark 5 has been formed at the recording position Pa1 on the substrate 10 by the data recording apparatus 1 described above. Accordingly, compared to a position where no recording mark 5 has been formed, the electrical resistance is reduced corresponding to the amount of carbon that constructs the recording mark 5. For this reason, the current measured at the recording position Pa1 (i.e., at a position where a recording mark 5 has been formed) is larger than the current measured when the probe 53 contacts a position where a recording mark 5 has not been formed. Since the three types of recording marks 5a to 5c with different heights H1 to H3 have been formed on the information recording medium 3 as described above, due to the difference in electrical resistance caused by the difference in the heights (thicknesses) H of the recording marks 5 formed at the recording positions P, the current measured by the measuring unit 55 also differs. As a specific example, if a recording mark 5a has been formed, a current of around 1 pA is measured, if a recording mark 5b has been formed, for example, a current of around 3 pA is measured, and if a recording mark 5c has been formed, for example, a current of around 8 pA is measured. If a recording mark 5 has not been formed, a minute current of around 0.2 pA is measured

On the other hand, the measuring unit 55 that has measured the current at the recording position Pa1 generates the measurement data Dmi showing the measurement result (i.e., the measured current) and outputs the measurement data Dmi to the control unit 58. In response the control unit 58 stores the outputted measurement data Dmi in the storage unit 59 and controls the moving mechanism 23 to move the probe 53 in a state where the probe 53 remains in contact with the surface of the substrate 10 to position the probe 53 at the recording position Pb1 on the substrate 10. Next, the control unit 58 controls the measuring unit 55 to start measuring the current at the recording position Pb1. In this way, by measuring the current at the recording position P whenever the probe 53 is moved, the current at each of the recording positions Pa1 of the information recording medium 3 is measured and measurement data Dmi showing the measurement results is stored in the storage unit 59.

When the process that measures the current at the recording positions P has been completed, the control unit 58 specifies, based on the reproduction reference data Drr and the measurement data Dmi stored in the storage unit 59, whether a recording mark 5 is formed at the respective recording positions P on the information recording medium 3 and, when a recording mark 5 has been formed, which of the recording marks 5a to 5c has been formed. More specifically, when the measurement data Dmi is 0.2 pA or below, it is specified that a recording mark 5 is not formed, when the measurement data Dmi is 1 pA±0.5 pA, it is specified that a recording mark 5a is formed, when the measurement data Dmi is 3 pA±1 pA, it is specified that a recording mark 5b is formed, and when the measurement data Dmi is 8 pA±2 pA, it is specified that a recording mark 5c is formed. Next, the control unit 58 decrypts the specified result in accordance with a predetermined algorithm to generate the data Dre and outputs the data Dre to the external apparatus. By doing so, a series of data reproducing processes by the data reproducing apparatus 2 is completed.

In this way, according to the data reproducing method that uses the data reproducing apparatus 2, the data Dre can he reproduced from the information recording medium 3 on which the data Dre has been recorded in accordance with the data recording method that uses the data recording apparatus 1. When doing so, the control unit 58 controls the measuring unit 55 to apply a voltage between a predetermined position on the substrate 10 of the information recording medium 3 (in this example, opposite ends of the substrate 10) and a position on one surface that differs to the predetermined positions (in this example, one of the recording positions Pa1, Pa2, . . . , Pb1, Pb2, . . . ) and measure the current at each position, and reproduces the data Dre based on the measured current By doing so, unlike the conventional recording/reproducing method that detects the concaves and convexes on a land and reproduces data based on position information of positions where convexes are detected, even if concaves and convexes of a certain size are present on the data recording surface of the substrate 10, it will still be possible to avoid having recording marks 5 erroneously detected. Since it is not necessary to make the surface (the data recording surface) of the substrate 10 extremely smooth, it is possible to sufficiently reduce the manufacturing cost of the information recording medium 3 and to properly reproduce data while avoiding data reproducing errors.

### Second Embodiment

A second embodiment of a data recording method, a data recording apparatus and an information recording medium according to the present invention will be described next with reference to the drawings. Note that component elements that are the same as the component elements of the data recording apparatus 1, the data reproducing apparatus 2, and the information recording medium 3 described above in the first embodiment have been assigned the same reference numerals and description thereof has been omitted.

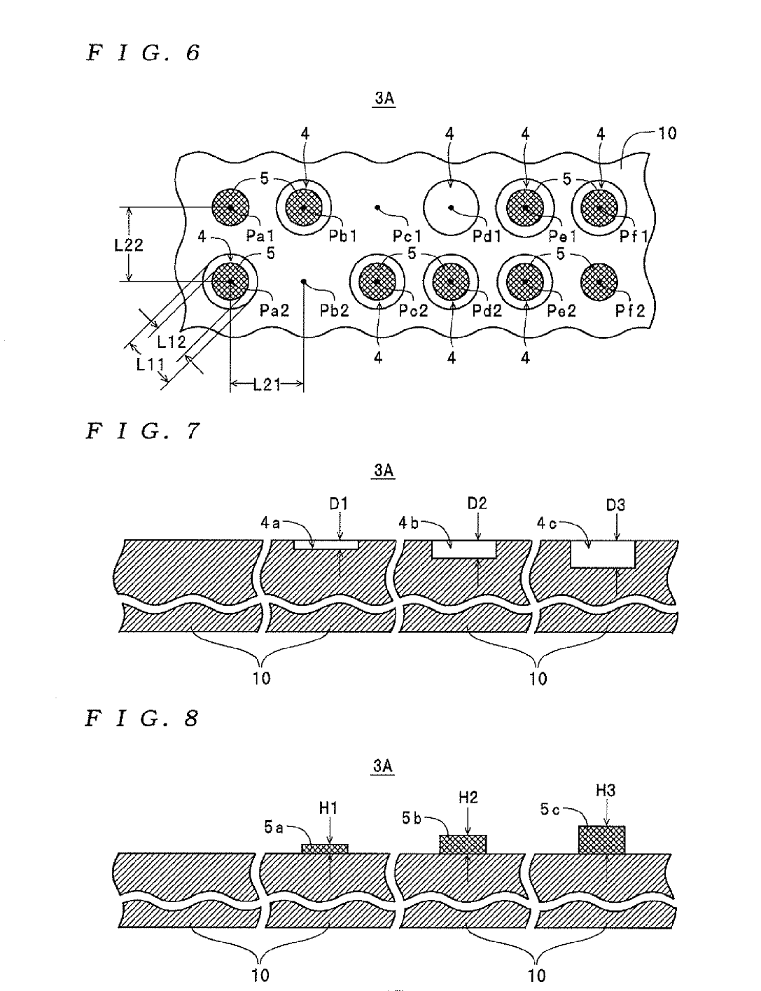

The data recording apparatus 1A shown in FIG. 1 is an apparatus that records data according to the data recording method according to the present invention, and is constructed in the same way as the data recording apparatus 1 described above. In the data recording apparatus 1A, the control unit 17 forms a plurality of concaves 4 (see FIG. 6) and a plurality of recording marks 5 on the substrate 10 corresponding to the content of the data Dre outputted from the external apparatus to record the data Dre (i.e., the control unit 17 carries out the data recording method according to the present invention).

As shown in FIG. 6, in the data recording apparatus 1A, the recording data Dre is recorded by forming the concaves 4 at recording positions P (“second recording positions” for the present invention) set corresponding to the content of the data Dre out of a large number of recording positions Pa1, Pb1, . . . Pa2, Pb2, . . . (referred to as the “recording positions P” when no distinction is required) set in a grid on the substrate 10 with a density of 8×10¹⁰ positions per square inch, for example, and by forming the recording marks 5 at recording positions P (“first recording positions” for the present invention) set corresponding to the content of the data Dre out of the recording positions P. Note that in the following description, the substrate 10 on which the plurality of concaves 4 and the plurality of recording marks 5 have been formed is also referred to as the information recording medium 3A.

It the diameter L11 of the concaves 4 is too small relative to the diameter L12 of the recording marks 5, when the recording process described later is carried out for the recording data Dre, there is the risk of it being difficult to form recording marks 5 inside the concaves 4 (i.e., on the base surfaces of the concaves 4). Accordingly, the diameter L11 of the concaves 4 and the diameter L12 of the recording marks 5 should preferably be set so that the diameter L11 of the concaves 4 is at least 110% of the diameter L12 of the recording marks 5. Note that in the present embodiment, by setting the diameter L11 of the concaves 4 at 125 nm and the diameter L12 of the recording marks 5 at 100 nm, the diameter L11 of the concaves 4 is set at 125% of the diameter L12 of the recording marks 5. Also, if adjacent recording positions P are too far apart on the substrate 10 (i.e., if the pitch of the recording positions P is too wide), there is a fall in the number of concaves 4 and recording marks 5 that can be formed per unit area on the substrate 10, which prevents the data Dre from being recorded at high density. Accordingly, to realize high-density recording, adjacent recording positions P should be set as close together as possible on the substrate 10. More specifically, if the diameter L11 of the concaves 4 is set at 125 nm and the diameter L12 of the recording marks 5 is set at 100 nm, as one example, the center-to-center distances L21, L22 between the adjacent recording positions P should preferably be set at 200 nm or below (at 160% or below of the diameter L11 of the concaves 4 or at 200% or below of the diameter L12 of the recording marks 5).

On the other hand, when the adjacent recording positions P are too close together on the substrate 10, the concaves 4 formed at adjacent recording positions P will become continuous along the surface of the substrate 10 and when the adjacent recording positions P are positioned even closer together, the recording marks 5 formed at adjacent recording positions P will overlap each other. As a result, it becomes difficult to individually distinguish the concaves 4 and the recording marks 5 when reproducing the data Dre, leading to the risk of reproduction errors. Accordingly, to avoid a situation where the concaves 4 formed at adjacent recording positions P on the substrate 10 are continuous and a situation where the recording marks 5 formed at adjacent recording positions P overlap, it is necessary to make the center-to-center distances L21, L22 of the adjacent recording positions P on the substrate 10 sufficiently wider than the diameter L11 of the concaves 4 and the diameter L12 of the recording marks 5. More specifically, if the diameter L11 of the concaves 4 is set at 125 nm and the diameter L12 of the recording marks 5 is set at 100 nm, as one example, the center-to-center distances L21, L22 of the adjacent recording positions P should preferably be set at 150 nm or above (i.e., 120% or greater of the diameter L11 of the concaves 4 or 150% or greater of the diameter L12 of the recording marks 5). Note that in the present embodiment, the center-to-center distances L21, L22 of the adjacent recording positions P are set at 150 nm. Note also that in FIG. 6, the center-to-center distances L21, L22 of the recording positions P have been exaggerated for ease of understanding the present invention.

As shown in FIGS. 7 and 8, on the data recording apparatus 1A, combinations of three types of concaves 4a to 4c with different depths D and three types of recording marks 5a to 5c with different heights H are formed at recording positions P in accordance with the content of the data Dre to record the data Dre using multivalue data. When doing so, as one example, the concaves 4a are formed so that the depth D1 thereof is in a range of 1 nm to 3 nm, inclusive (as one example, 2 nm), the concaves 4b are formed so that the depth D2 thereof is in a range of 4 nm to 6 nm, inclusive (as one example, 5 nm), and the concaves 4c are formed so that the depth D3 thereof is in a range of 11 nm to 13 nm, inclusive (as one example, 12 nm). Also, as one example, the recording marks 5a are formed so that the height H1 thereof is in a range of 1 nm to 3 nm, inclusive (as one example, 2 nm), the recording marks 5b are formed so that the height H2 thereof is in a range of 4 nm to 6 nm, inclusive (as one example, 5 nm), and the recording marks 5c are formed so that the height H3 thereof is in a range of 11 nm to 13 nm, inclusive (as one example, 12 nm). Note that the recording marks 5a to 5c are formed so that the electrical resistance thereof differs due to the difference in heights (the thicknesses of the recording material) H.

When recording the data Dre using the data recording apparatus 1A, first, as shown in FIG. 1, the substrate 10 is set on the substrate mounting table 22 with the data recording surface facing upward. Next, the control unit 17 controls the extraction pump 12 to evacuate the air inside the vacuum case 21 and controls the heater 32 to heat the phenanthrene inside the gas source housing unit 31 to produce the hydrocarbon gas G inside the gas source housing unit 31. After this, when the data Dre has been outputted from the external apparatus, the control unit 17 controls the extraction pump 33 to supply the hydrocarbon gas G from the gas source housing unit 31 via the pipe 34a to the nozzle 34 and controls the moving mechanism 23 to move the substrate mounting table 22 so that a recording position Pa1, for example, on the substrate 10 is positioned below the ion beam irradiating unit 14. Next, based on the recording procedure data Dp stored in the storage unit 18 and the data Dre, the control unit 17 controls the ion beam irradiating unit 14 to irradiate the recording position Pa1 on the substrate 10 with the ion beam IB that has been adjusted to a mark forming power (i.e., a power that is equal to or lower than a “predetermined power” for the present invention). More specifically, the recording position Pa1 is irradiated with an ion beam IB of a lower power than the concave forming power used when forming any out of the concaves 4a to 4c as described later.

When doing so, secondary electrons are generated from the substrate 10 by the ion beam IB emitted toward the recording position Pa1 and the hydrocarbon gas G blown out from the nozzle 34 toward the substrate 10 is separated into a gas component and a solid component (carbon) by the influence of the secondary electrons. The separated gas component is evacuated by the extraction pump 12 from the vacuum case 21 and the carbon that is the solid component accumulates on the substrate 10 (at the recording position Pa1). By doing so, as shown in FIG. 6, a recording mark 5 that is an accumulation of carbon is formed at the recording position Pa1 (i.e., the recording mark 5 is formed by vapor-phase growth). When doing so, the blanking control unit 42 adjusts the irradiation time for which the substrate is irradiated with the ion beam IB (i.e., adjusts the amount of irradiation with the recording beam) in accordance with control by the control unit 17 and thereby changes the amount of carbon that accumulates on the substrate 10 to form one out of the recording marks 5a to 5c with the different heights H1 to H3 at the recording position Pa1 (the “mark forming process” for the present invention).

After this, the control unit 17 controls the deflection electrode unit 46 of the ion beam irradiating unit 14 to change the irradiated position of the ion beam IB to the recording position Pb1 on the substrate 10 which is then irradiated with the ion bean IB which has been adjusted to the concave forming power (a power that exceeds the “predetermined power” for the present invention). More specifically, the recording position Pb1 is irradiated with an ion beam IB of a higher power than the mark forming power irradiated when forming any of the recording marks 5a to 5c described above. When doing so, the surface of the substrate 10 is chipped away by the irradiated ion beam IB of the high power to form a concave 4 at the recording position Pb1. When doing so, the blanking control unit 42 adjusts the irradiation time for which the substrate 10 is irradiated with the ion beam IB (i.e., adjusts the amount of irradiation with the recording beam) in accordance with control by the control unit 17 and thereby changes the depth D of the concave 4 on the substrate 10 to form one out of the concaves 4a to 4c with the different depths D1 to D3 at the recording position Pb1 (the “concave forming process” for the present invention). Next, the control unit 17 controls the ion bean irradiating unit 14 to have the substrate 10 continuously irradiated with the ion bean IB and lowers the power of the ion beam IB to the mark forming power. When doing so, the hydrocarbon gas G is separated into a gas component and a solid component by the ion beam IB emitted toward the recording position Pb1 (i.e., the base surface of the concave 4) and the carbon that is the solid component accumulates on the substrate 10 (i.e., on the base surface of the concave 4 formed at the recording position Pb1). By doing so, as shown in FIG. 6, a recording mark 5 that is an accumulation of carbon is formed on the base surface of the concave 4 at the recording position Pb1. When doing so, the blanking control unit 42 adjusts the irradiation time for which the substrate 10 is irradiated with the ion beam IB in accordance with control of the control unit 17 and thereby changes the amount of carbon that accumulates on the substrate 10 to form one out of the recording marks 5a to 5c with the different heights H1 to H3 at the recording position Pb1.

When forming a concave 4 and/or the recording mark 5 at a recording position P outside the range in which the ion beam IB can be deflected by the deflection electrode unit 46, the control unit 17 controls the moving mechanism 23 to move the substrate mounting table 22 so that the recording position P is positioned below the ion beam irradiating unit 14. In addition, when the formation of the concaves 4 and the recording marks 5 on the first row (the recording positions Pa1, Pb1, . . . ) out of the recording positions P set in a grid has been completed, the control unit 17 controls the moving mechanism 23 to move the substrate mounting table 22 so that the recording position Pa2 that is in the first column out of the second row of the recording positions P on the substrate 10 is positioned under the ion beam irradiating unit 14 and controls the ion beam irradiating unit 14 to emit the ion beam IB to form a concave 4 and/or a recording mark 5 at the recording position Pa2.

In this way, the control unit 17 successively carries out the concave forming process that forms a concave 4 at a recording position P (a “second recording position on the present invention) set corresponding to the content of the data Dre out of the recording positions P on the substrate 10 and the mark forming process that forms a recording mark 5 at a recording position P (a “first recording position on the present invention) set corresponding to the content of the data Dre out of the recording positions P. As a result, as shown in FIG. 6, the substrate 10 includes recording positions P such as the recording position Pa1 where only a recording mark 5 is formed without a concave 4 being formed, recording positions P such as the recording position Pb1 where a concave 4 is formed and a recording mark 5 is also formed on the base surface of the concave 4, recording positions P such as the recording position Pc1 where neither a concave 4 nor a recording mark 5 is formed, and recording positions P such as the recording position Pd1 where only a concave 4 is formed. The depths D of the concaves 4 formed at the recording positions P differ in accordance with the content of the data Dre and the heights H of the recording marks 5 formed at the recording positions P also differ in accordance with the content of the data Dre. Accordingly, the data Dre is recorded using one of sixteen patterns (i.e., sixteen values) that are combinations of the four types of concaves 4 with different depths D (including positions where the depth D is zero, that is, where no concave 4 is formed) and the tour types of recording marks 5 with different heights H (including positions where no recording mark 5 is formed).

In this way, according to the data recording method that uses the data recording apparatus 1A, the data Dre is recorded on the substrate 10 by carrying out the concave forming process that forms the concaves 4 at recording positions P (in this example, the recording positions Pb1, Pd1, etc.: the “second recording positions” for the present invention) set corresponding to the content of the data Dre to be recorded and the mark forming process that forms the recording marks 5, which have different electrical resistances to one surface of the substrate 10, by blowing out the hydrocarbon gas G (“recording mark forming gas”) onto one surface of the substrate 10 and emitting the ion beam IB (recording beam) at recording positions P (in this example, the recording positions Pa1, Pb1, etc.: the “first recording positions” for the present invention) set corresponding to the content of the data Dre to cause the carbon (recording material) in the hydrocarbon gas G to accumulate at the region irradiated with the ion beam IB. Unlike the conventional recording/reproducing method that forms gold dots (recording marks 5) by transferring gold from the probe tip to the disk, by housing a gas producing material (in this example, phenanthrene) for producing the hydrocarbon gas G in the gas supplying unit 13 (the gas source housing unit 31), it is possible to continuously form a large number of recording marks 5 without replacing recording components (such as the probe used in the conventional recording method) during the data recording process. Accordingly, a large amount of data can be recorded reliably and easily. Also, since the data Dre can be recorded as multivalue data on the substrate 10 using combinations of the presence/absence of concaves 4 and the presence/absence of the recording marks 5 at the respective recording positions P, unlike the conventional recording/reproducing method that records data according to the presence/absence of only recording marks (gold dots), it is possible to sufficiently raise the recording density of the data Dre that can be recorded per unit area of the substrate 10 without forming the concaves 4 and the recording marks 5 with a narrow pitch causing the risk of reproducing errors.

Also, according to the data recording method that uses the data recording apparatus 1A, by forming the concaves 4 (in the present example, the three types of concaves 4a to 4c) with depths D corresponding to the data content at the respective recording positions P during the concave 4 forming process, compared to a data recording method that records the data Dre by forming one type of concaves 4 (a method where the data Dre is recorded using combinations of the presence/absence of concaves 4 and the presence/absence of recording marks 5), it is possible to record the data Dre on the substrate 10 with a density that is increased by an amount corresponding to the ability to record multivalue data in accordance with the types of concaves 4.

Also, according to the data recording method that uses the data recording apparatus 1A, by forming a plurality of types of concaves 4 with different depths by adjusting the amount of irradiation with the ion beam IB, it is possible to reliably form the concaves 4 with the desired depths D at the recording positions P with a comparatively simple construction.

Also, according to the data recording method that uses the data recording apparatus 1A, by forming the concaves 4 at the recording positions P by emitting the ion beam IB with a power (the concave forming power) that exceeds the predetermined power in the concave forming process for the present invention and forming the recording marks 5 at the recording positions P by emitting the ion beam TB with a power (the mark forming power) that is equal to or below the predetermined power in the mark forming process for the present invention, it is possible to form the concaves 4 at the desired recording positions P with high precision while using a comparatively simple construction.

Also, according to the data recording method that uses the data recording apparatus 1A, by forming the recording marks 5 with electrical resistances set in accordance with the data content, compared to a data recording method that records data Dre by forming one type of recording marks 5 (by recording the data Dre using combinations of the presence/absence of the concaves 4 and the presence/absence of the recording marks 5), it is possible to record the data Dre on the substrate 10 with a density that is increased by an amount corresponding to the ability to record multivalue data in accordance with the types of recording marks 5.

Also, according to the data recording method that uses the data recording apparatus 1A, by adjusting the amount of irradiation with the ion beam IB to change the thickness of the recording material and thereby form a plurality of types of recording marks 5 with different electrical resistances, it is possible to reliably form recording marks 5 of desired heights H (recording marks 5 with desired electrical resistances) at the recording positions P using a comparatively simple construction.

Also, according to the information recording medium 3A on which the data Dre has been recorded according to the data recording method described above, by forming the concaves 4 at recording positions P (the “second recording positions”) set corresponding to the content of the data Dre and forming the recording marks 5, which have different electrical resistances to the surface of the substrate 10, at recording positions P (the “first recording positions”) set corresponding to the content of she data Dre, it is possible to record the data Dre as multivalue data based on combinations of the presence/absence of the concaves 4 and the presence/absence of the recording marks 5 at the recording positions P. Therefore, unlike an information recording medium on which data has been recorded according to the conventional recording/reproducing method that records data based on the presence/absence of recording marks (gold dots) only, it is possible to provide an information recording medium 3A on which the data Dre has been recorded with a sufficiently high recording density per unit area of the substrate 10.

In addition, according to the information recording medium 3A on which the data Dre has been recorded according to the data recording method described above, by forming the concaves 4 with depths D that correspond to the data content (in this example, one of three types of concaves with the depths D1 to D3) compared to an information recording medium 3A on which the data Dre has been recorded by forming one type of concaves 4 (an information recording medium 3A on which the data Dre has been recorded using combinations of the presence/absence of concaves 4 and the presence/absence of the recording marks 5), it is possible to provide an information recording medium 3A on which the data Dre has been recorded with a recording density per unit area of the substrate 10 that has been increased by an amount corresponding to the ability to record multivalue data in accordance with the types of concaves 4.

In addition, according to the information recording medium 3A on which the data Dre has been recorded according to the data recording method described above, by forming the recording marks 5 with electrical resistances that correspond to the data content, compared to an information recording medium 3A on which the data Dre has been recorded by forming one type of recording marks 5 (an information recording medium 3A on which the data Dre has been recorded using combinations of the presence/absence of concaves 4 and the presence/absence of the recording marks 5), it is possible to provide the information recording medium 3 on which the data Dre has been recorded with a recording density per unit area of the substrate 10 that has been increased by an amount corresponding to the ability to record multivalue data in accordance with the types of recording marks 5.

Note that the invention corresponding to this second embodiment is not limited to the construction or method described above. For example, although the concaves 4 and the recording marks 5 are formed by the data recording apparatus 1A described above by irradiating the substrate 10 with the ion beam IB during the data recording process, it is possible to use a construction that forms the concaves 4 on the substrate 10 by irradiation with various types of charged-particle beam, such as an electron beam, in place of the ion beam IB, and/or a construction that forms the recording marks 5 by accumulating a recording material by irradiation with various types of charged-particle beam. When doing so, it is possible to use a construction that uses a charged-particle beam to form the concaves 4 and a different type of charged-particle beam to form the recording marks 5. Also, although the data recording apparatus 1A is constructed so that the blanking control unit 42 adjusts the irradiation time of the ion beam IB to change the amount of irradiation of the recording positions P and thereby form the concaves 4a to 4c with the different depths D1 to D3 and the recording marks 5a to 5c with the different heights H1 to H3, it is possible to use a construction where the power of the ion beam IB outputted from the ion beam irradiating unit 14 is adjusted to change the amount of irradiation with the ion beam IB and thereby form the concaves 4a to 4c with the different depths D1 to D3 and the recording marks 5a to 5c with the different heights H1 to H3.

The number of types of concaves 4 (the number of different depths D) is not limited to three, and it is possible to use a construction where the data Dre is recorded as multivalue data by forming two or more types of concaves 4. Also, the number of types of recording marks 5 is not limited to three, and it is possible to use a construction where the data Dre is recorded as multivalue data by forming two or more types of recording marks 5. It is also possible to use a construction where the data Dre is recorded by forming one type of concaves 4 with the same depth D across the entire substrate 10 and/or a construction where the data Dre is recorded by forming one type of recording marks 5 with the same height H across the entire substrate 10. When doing so, if the pitch of the recording positions P (the center-to-center distances L21, L22) is set at 200 nm and the data Dre is recorded as multivalue data using combinations of three types of concaves 4a to 4c and three types of recording marks 5a to 5c as in the example described above, data can be recorded a high density of around 190 Gbit per square inch. With the same conditions, if the data Dre is recorded as multivalue data using two hundred types of concaves 4 and two hundred types of recording marks 5, data can be recorded at a high density of around 840 Tbit per square inch. When multivalue recording is not carried out (i.e., when the data Dre is recorded using combinations of the presence/absence of concaves 4 and the presence/absence of the recording marks 5), data can be recorded at a high density of around 85 Gbit per square inch.

The method of changing the electrical resistance of the recording marks 5 formed at the recording positions P is not limited to the data recording method described above that changes the height (thickness) H of the carbon accumulated on the substrate 10. For example, it is possible to use a method that forms recording marks 5 composed of solid components with different electrical resistances on the substrate 10. To do so, a construction is used that can blow out two or more types of recording mark forming gases, where the electrical resistance of the solid component that will be separated by irradiation with the ion beam IB differs, onto the substrate 10 and the recording mark forming beam is emitted while blowing one of the recording mark forming gases onto the substrate 10 in accordance with the content of the data Dre. In this way, by forming a plurality of types of recording marks 5 with different electrical resistances by setting one type out of a plurality of types of recording mark forming gases with different types of recording materials during the mark forming process for the present invention, it is possible to record the data Dre as multivalue data by forming recording marks 5 of the desired electrical resistances without greatly varying the height H of the recording marks 5 at different recording positions P.

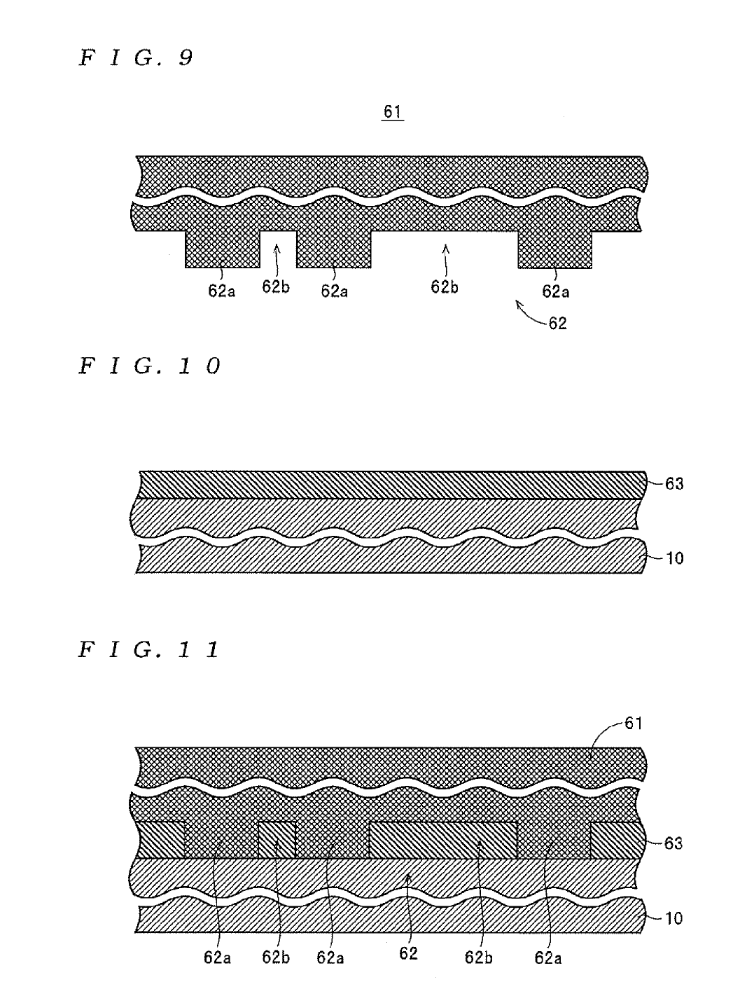

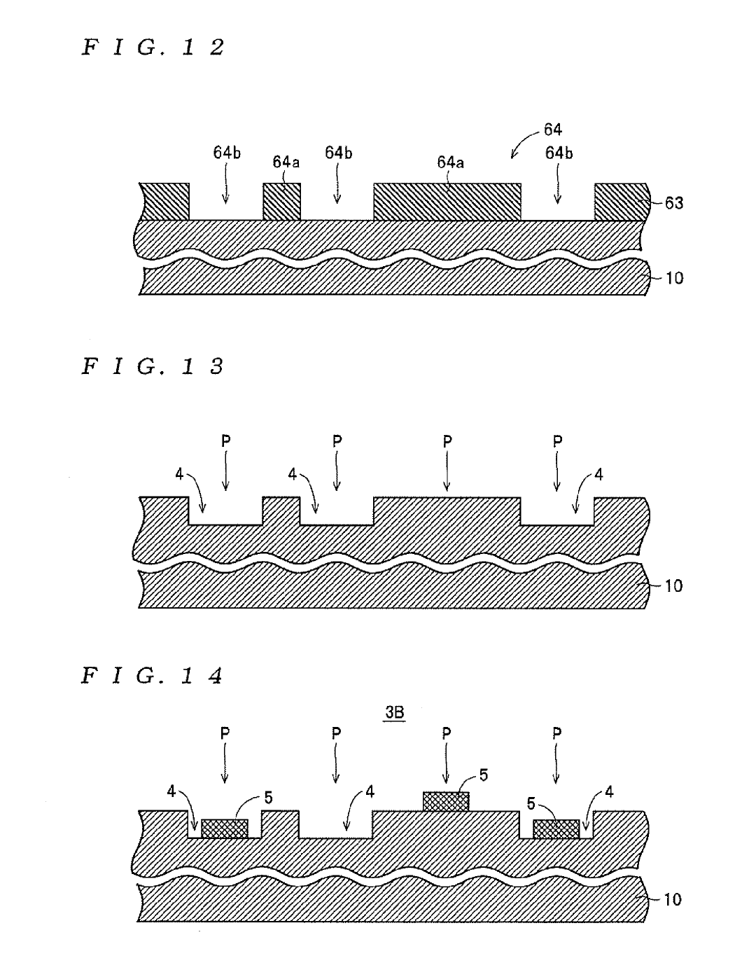

Also, although a method of forming the concaves 4 by irradiating the recording positions P on the substrate 10 with the ion beam IB that has been adjusted to the concave forming power has been described, the concave forming process in the data recording method according to the present invention is not limited to such method. For example, it is possible to use a method that forms concaves 4 at desired recording positions P on the substrate 10 by carrying out an imprinting process and an etching process. More specifically, in this method, as shown in FIG. 9, first a stamper 61 with a concave/convex pattern 62 in which a plurality of cylindrical convexes 62a are formed in accordance with the positions of the recording positions P where the concaves 4 are to be formed is manufactured. Note that there are no particular limitations on the method of manufacturing the stamper 61 and it is possible to manufacture the stamper according to a variety of well-known stamper manufacturing methods. Next, as shown in FIG. 10, a resist layer 63 is formed by applying a resist onto the substrate 10. After this, as shown in FIG. 11, by pressing the convex/concave pattern 62 of the stamper 61 onto the resist layer 63 on the substrate 10 using a press, for example, the convexes 62a of the stamper 61 are pressed into the resist layer 63. When doing so, due to the convexes 62a being pressed in, the resist (the resist layer 63) moves inside the concaves 62b rear the convexes 62a from the positions where the convexes 62a are pressed in. After this, by separating the stamper 61 from the resist layer 63, as shown in FIG. 12, the convex/concave pattern 62 of the stamper 61 is transferred to the resist layer 63 to form the convex/concave pattern 64 on The substrate 10. When doing so, in the convex/concave pattern 64, concaves 64b are formed corresponding to the convexes 62a of the stamper 61 and convexes 64a are formed corresponding to the concaves 62b of the stamper 61.

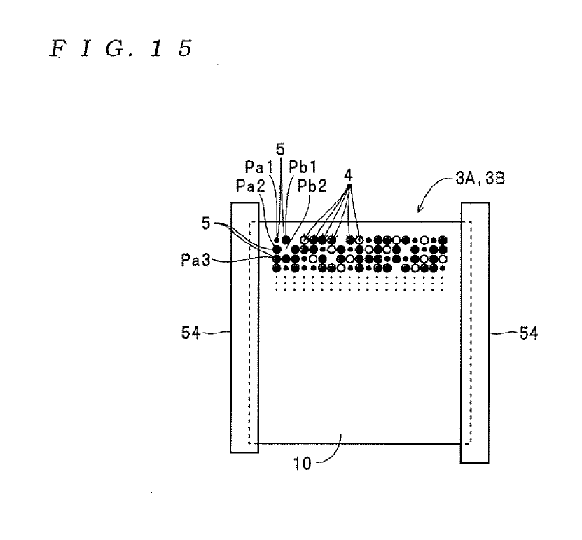

Next, an etching process is carried out on the substrate 10 using the convex/concave pattern 64 (i.e., the resist layer 63) formed on the substrate 10 as a mask. When doing so, parts of the substrate 10 exposed from the convexes 64a of the convex/concave pattern 64 (i.e., the base surfaces of the concaves 64b) are etched, so that as shown in FIG. 13, a plurality of concaves 4 are formed in the surface of the substrate 10. This completes the concave forming process for the present invention. Next, the substrate 10 for which the formation of the concaves 4 has been completed is set in the data recording apparatus 1A described above, and by simultaneously blowing out the hydrocarbon gas G onto the substrate 10 inside the vacuum case 21 and emitting the ion beam IB that has been adjusted to the mark forming power at the recording positions P where the recording marks 5 are to be formed, as shown in FIG. 14, the recording marks 5 are formed on the surface of the substrate 10 or on the base surfaces of the concaves 4. By doing so, the mark forming process is completed and an information recording medium 3B on which data Dre has been recorded as multivalue data in the same way as with the data recording method described above is completed. In this way, by using a method where the concaves 4 are formed in the substrate 10 by a combination of an imprinting process and an etching process, it is possible to form a plurality of concaves 4 in the substrate 10 in a short time compared to the concave forming process that forms the concaves 4 in the substrate 10 by emitting an ion beam IB adjusted to the concave forming power. Accordingly, a large number of information recording media 3B can be manufactured in a short time. Also, compared to the method that forms the convex/concave pattern 64 on the substrate 10 by drawing a desired pattern (as one example, a planar pattern corresponding to the concaves 4) on the resist layer 63 of the substrate 10 using an electron beam lithography apparatus and then developing the resist, it is possible to form the convex/concave pattern 64 by merely pressing the stamper 61 (the convex/concave pattern 62) into the resist layer 63, and therefore the concaves 4 can be formed in a short time in a plurality of substrates 10.

Note that the method of forming the concaves 4 in the substrate 10 before the recording marks 5 are formed is not limited to a formation method composed of the imprinting process and the etching process described above, and it is also possible to use a method that forms a substrate in which a plurality of concaves 4 are formed by injection molding or a method that forms a substrate in which a plurality of concaves 4 are formed by applying various types of resin material such as UV curing resin onto the convex/concave pattern 62 of the stamper 61 and then hardening the resin material.

Next, a second embodiment of a data reproducing method and a data reproducing apparatus according to the present invention will be described with reference to the drawings.

A data reproducing apparatus 2A shown in FIG. 4 is an apparatus for reproducing (reading) data in accordance with the data reproducing method according to the present invention, is constructed in the same way as the data reproducing apparatus 2 described above, as one example is connected to an external apparatus such as a personal computer, and is constructed so as to be capable of reproducing (i.e., reading) data Dre from the information recording medium 3A or 3B (the substrate 10 on which the concaves 4 and the recording marks 5 have been formed) on which data Dre has been recorded and outputting the data Dre to the external apparatus. With the data reproducing apparatus 2A, when the moving mechanism 52 has moved the probe 53 in a state where the probe 53 is in contact with the body being measured (the information recording medium 3A or the like), the amount by which the probe 53 moves up and down with respect to the moving mechanism 52 (i.e., toward and away from the moving mechanism 52) due to the concaves and convexes in the surface of the body being measured is detected and the detection result is outputted as a concave/convex detection signal. In the data reproducing apparatus 2A, the moving mechanism 52, the probe 53, and the control unit 58 together construct a “distance measuring unit” for the present invention that measures a depth (distance) from a reference plane at each recording position P based on the concaves and convexes of the substrate 10 detected by the control unit 58 via the probe 53. In the data reproducing apparatus 2A, the following reproducing process is carried out with the surface of the substrate 10 (at positions where the concaves 4 and the recording marks 5 are not formed) as the “reference plane” for the present invention.

In the data reproducing apparatus 2A, the control unit 58 carries out overall control over the components of the data reproducing apparatus 2A and reproduces (reads) the data Dre From the information recording medium 3A based on the concaves and convexes (i.e., the distances from the reference plane) of the substrate 10 detected via the probe 53 and the current (measurement data Dmi) measured at each position (the recording positions P described above) on the information recording medium 3A by the measuring unit 55 (i.e., the control unit 58 carries out the data reproducing method according to the present invention). In addition, in the data reproducing apparatus 2A, the storage unit 59 stores the reproduction reference data Drr for reproducing the data Dre based on the current measured by the measuring unit 55, the measurement data Dmi outputted from the measuring unit 55, and the measurement data Dml that can specify the concaves and convexes (distances from the reference plane) of the substrate 10 detected via the probe 53.

When reproducing the data Dre using the data reproducing apparatus 2A, first the information recording medium 3A, for example, is set on the substrate mounting table 51 with the data recording surface facing upward, and the electrodes 54 are disposed at both ends of the substrate 10. Next, when a predetermined operation button of the operating unit 56 has been operated to designate a start of reproduction of the data Dre, the control unit 58 controls the moving mechanism 52 to move the probe 53 along the surface of the substrate 10 while in contact with the surface. Next, the control unit 58 detects the concaves and convexes of the surface of the substrate 10 via the probe 53 and controls the measuring unit 55 to start measuring the current at the respective positions on the substrate 10. When doing so, the measuring unit 55 measures, via the probe 53 and the electrodes 54, the current that flows between one end (one of the positions contacted by the electrodes 54: “predetermined positions” for the present invention) of the substrate 10 and the position on the substrate 10 contacted by the probe 53 on the substrate 10.

At the recording position Pa1, for example, on the substrate 10, the recording mark 5 has been formed by the data recording apparatus 1A described above without a concave 4 being formed. Accordingly, compared to a position where no recording mark 5 has been formed, the electrical resistance at the recording position Pa1 is reduced corresponding to the amount of carbon that constructs the recording mark 5. For this reason, the current measured at the recording position Pa1 (a position where a recording mark 5 is formed) is larger than the current measured when the probe 53 contacts a position where a recording mark 5 has not been formed. Since the three types of recording marks 5a to 5c with different heights H1 to H3 are formed at recording positions P on the information recording medium 3A as described above, due to the difference in electrical resistance caused by the difference in the heights (thicknesses) H of the formed recording marks 5, the current measured by the measuring unit 55 also differs. As one specific example, if a recording mark 5a has been formed, a current of around 1 pA is measured, if a recording mark 5b has been formed, a current of around 3 pA is measured, and it a recording mark 5c has been formed, a current of around 8 pA is measured. If a recording mark 5 has not been formed, a minute current of around 0.2 pA is measured. Accordingly, the measuring unit 55 generates the measurement data Dmi showing the measurement result (i.e., the current) and outputs the measurement data Dmi to the control unit 58.

The control unit 58 calculates the distance between the front tip of the probe 53 that is in contact with the recording position Pa1 and the reference plane (in this example, the surface of the substrate 10 at positions where concaves 4 are not formed) based on the concaves and convexes of the substrate 10 detected via the probe 53 and stores the calculation result in the storage unit 59 as the measurement data Dml. Here, the control unit 58 calculates the amount moved by the probe 53 in the up-down direction with respect to the moving mechanism 52 (i.e., the direction toward and away from the substrate 10) based on the concave/convex detection signal outputted from the moving mechanism 52, for example, and calculates the front end of the probe 53 and the reference plane based on the calculation result for the movement amount.

Next, the control unit 58 controls the moving mechanism 52 to move the probe 53 to the recording position Pb1 on the substrate 10 while keeping the probe 53 in contact with the surface of the substrate 10. Next, the control unit 58 calculates the distance between the front tip of the probe 53 that is in contact with the recording position Pb1 and the reference plane based on the concaves and convexes of the surface of the substrate 10 detected via the probe 53 and stores the calculation result in the storage unit 59 as the measurement data Dml (the “distance measuring process” for the present invention), and also controls the measuring unit 55 to start measuring the current at the recording position Pb1 and stores the measurement data Dmi outputted from the measuring unit 55 in the storage unit 59 (the “current measuring process” for the present invention). In this way, the control unit 58 calculates the distance between the probe 53 and the reference plane at the recording position P whenever the probe 53 is moved and has the measuring unit 55 measure the current. When the measurement process for the distance from the reference plane and the measurement process for the current have been completed for each recording position P, the control unit 58 specifies the values recorded at the recording positions P on the information recording medium 3A based on the measurement data Dmi, Dml described above for each recording position P and the reproduction reference data Drr stored in the storage unit 59.

More specifically, on determining based on the measurement data Dml that the distance from the reference plane is substantially zero (that is, when the front tip of the probe 53 in contact with the recording position P and the reference plane are positioned on substantially the same plane), the control unit 58 determines that a concave 4 is not formed at the recording position P. When the distance from the reference plane is in a range of 1 nm to 3 nm, inclusive, it is determined that a concave 4a is formed at the recording position P, when the distance from the reference plane is in a range of 4 nm to 6 nm, inclusive, it is determined that a concave 4b is formed at the recording position P, and when the distance from the reference plane is in a range of 11 nm to 13 nm, inclusive, it is determined that a concave 4c is formed at the recording position P. In addition, based on the measurement data Dml, the control unit 58 determines that a recording mark 5 is not formed at the recording position P when the current is 0.2 pA or below, that a recording mark 5a is formed at the recording position P when the current is 1 pA±0.5 pA, that a recording mark 5b is formed at the recording position P when the current is 3 pA±1 pA, and that a recording mark 5c is formed at the recording position P when the current is 8 pA±2 pA. Next, the control unit 58 decrypts the specified result in accordance with a predetermined algorithm to generate the data Dre and outputs the data Dre to the external apparatus. By doing so, a series of data reproducing processes by the data reproducing apparatus 2A is completed,

In this way, according to the data reproducing method that uses the data reproducing apparatus 2A, when reproducing the data Dre from an information recording medium on which the data Dre has been recorded in accordance with any of the data recording methods described above, by carrying out a distance measuring process that measures the distance from the reference plane at the respective positions on the surface of the substrate 10 and a current measuring process that applies a voltage between respective positions on the surface of the substrate 10 and one of the predetermined positions on the substrate 10 that differ to the respective positions and measures the current that flows between the respective positions and one of the predetermined positions, the data Dre is reproduced based on the distance measured at the respective positions by the distance measuring process and the current measured at the respective positions by the current measuring process. By doing so, it is possible to reliably and correctly read the data Dre from the information recording media 3A, 3B on which the data Dre has been recorded as multivalue data using combinations of the presence/absence of concaves 4 and the distance from the reference plane and the presence/absence of recording marks 5 and the current values at each recording position P.

What is claimed is:

1. A data recording method that records data, comprising:
a mark forming process that blows recording mark forming gas onto a surface of an information recording medium substrate and irradiates first recording positions on the surface set corresponding to a content of the data to be recorded using a recording mark forming beam to cause recording material included in the recording mark forming gas to accumulate at regions irradiated with the recording mark forming beam and form recording marks, which have a different electrical resistance to the surface of the information recording medium substrate, at the first recording positions.

2. A data recording method according to claim 1, wherein the data is recorded on the information recording medium substrate by executing a concave forming process that forms concaves at second recording positions on the surface set corresponding to the content of the data to be recorded and the mark forming process.

3. A data recording method according to claim 1, wherein the recording marks are formed at the first recording positions with electrical resistances that correspond to the content of the data to be recorded.

4. A data recording method according to claim 2, wherein the recording marks are formed at the first recording positions with electrical resistances that correspond to the content of the data to be recorded.

5. A data recording method according to claim 2, wherein in the concave forming process, the concaves are formed at the second recording positions with depths that correspond to the content of the data to be recorded.

6. A data recording method according to claim 4, wherein in the concave forming process, the concaves are formed at the second recording positions with depths that correspond to the content of the data to be recorded.

7. A data recording method according to claim 3, wherein a plurality of types of recording marks with respectively different electrical resistances are formed on the surface by adjusting the amount of irradiation with the recording mark forming beam at each first recording position where the recording marks are to be formed to change the thickness of the recording material that accumulates on the surface in accordance with the content of the data.

8. A data recording method according to claim 4, wherein a plurality of types of recording marks with respectively different electrical resistances are formed on the surface by adjusting the amount of irradiation with the recording mark forming beam at each first recording position where the recording marks are to he formed to change the thickness of the recording material that accumulates on the surface in accordance with the content of the data.

9. A data recording method according to claim 6, wherein a plurality of types of recording marks with respectively different electrical resistances are formed on the surface by adjusting the amount of irradiation with the recording mark forming beam at each first recording position where the recording marks are to be formed to change the thickness of the recording material that accumulates on the surface in accordance with the content of the data.

10. A data recording method according to claim 3, wherein a plurality of types of recording marks with respectively different electrical resistances are formed by using one out of a plurality of types of recording mark forming gases that include different types of recording material.

11. A data recording method according to claim 4, wherein a plurality of types of recording marks with respectively different electrical resistances are formed by using one out of a plurality of types of recording mark forming gases that include different types of recording material.

12. A data recording method according to claim 6, wherein a plurality of types of recording marks with respectively different electrical resistances are formed by using one out of a plurality of types of recording mark forming gases that include different types of recording material.

13. A data recording method according to claim 5, wherein a plurality of types of concaves with respectively different depths are formed by adjusting the amount of irradiation with the recording beam.

14. A data recording method according to claim 6, wherein a plurality of types of concaves with respectively different depths are formed by adjusting the amount of irradiation with the recording beam.

15. A data recording method according to claim 2, wherein during the concave forming process, the concaves are formed by irradiating the second recording positions with the recording beam with a power that exceeds a predetermined power, and during the mark forming process, the recording marks are formed by irradiating the first recording positions with the recording beam with a power that is no greater than the predetermined power.

16. A data recording method according to claim 4, wherein during the concave forming process, the concaves are formed by irradiating the second recording positions with the recording beam with a power that exceeds a predetermined power, and during the mark forming process, the recording marks are formed by irradiating the first recording positions with the recording beam with a power that is no greater than the predetermined power.

17. A data recording method according to claim 5, wherein during the concave forming process, the concaves are formed by irradiating the second recording positions with the recording beam with a power that exceeds a predetermined power, and during the mark forming process, the recording marks are formed by irradiating the first recording positions with the recording beam with a power that is no greater than the predetermined power.

18. A data recording method according to claim 6,
wherein during the concave forming process, the concaves are formed by irradiating the second recording positions with the recording beam with a power that exceeds a predetermined power, and during the mark forming process, the recording marks are formed by irradiating the first recording positions with the recording beam with a power that is no greater than the predetermined power.

19. A data reproducing method that reproduces data from an information recording medium on which data has been recorded in accordance with the data recording method according to claim 1,
wherein by applying a voltage between a predetermined position on the information recording medium substrate and a position on the surface that differs to the predetermined position and measuring the current that flows between the predetermined position and the position on the surface, the data recorded on the information recording medium substrate is reproduced based on the current measured at each position.

20. A data reproducing method that reproduces data from an information recording medium on which data has been recorded in accordance with the data recording method according to claim 2,
wherein by executing a distance measuring process that measures a distance from a reference plane at each position on the surface of the information recording medium substrate and executing a current measuring process that applies a voltage between each position on the surface and a predetermined position on the information recording medium substrate that differs to the position on the surface and measures the current that flows between the position on the surface and the predetermined position, the data recorded on the information recording medium is reproduced based on the distance measured at each position by the distance measuring process and the current measured at each position by the current measuring process.

21. A data recording apparatus that records data, comprising:
a gas blowing unit that blows recording mark forming gas onto a surface of an information recording medium substrate;
a beam irradiating unit that irradiates the information recording medium substrate with a recording mark forming beam; and
a control unit that controls the gas blowing unit and the beam irradiating unit, wherein the control unit controls the gas blowing unit to blow the recording mark forming gas onto the surface and, at first recording positions on the surface set corresponding to the content of the data to be recorded, controls the beam irradiating unit to emit the recording mark forming beam to cause recording material in the recording mark forming gas to accumulate at regions irradiated with the recording mark forming beam to form recording marks, which have a different electrical resistance to the surface of the information recording medium substrate, at the first recording positions.

22. A data recording apparatus comprising:
a beam irradiating unit that irradiates one surface of an information recording medium substrate with a recording beam;
a gas blowing unit that blows recording mark forming gas onto the surface; and
a control unit that controls the beam irradiating unit and the gas blowing unit, wherein the control unit records data on the information recording medium substrate by carrying out:
a concave forming process where the control unit controls the beam irradiating unit to irradiate second recording positions, which are set corresponding to the content of the data to be recorded out of a plurality of recording positions on the surface, with the recording beam whose power has been set greater than a predetermined power to form concaves at the second recording positions; and
a mark forming process where the control unit controls the gas blowing unit to blow the recording mark forming gas onto the surface and, at first recording positions set corresponding to the content of the data to be recorded out of the recording positions, controls the beam irradiating unit to emit the recording beam with a power that is no greater than the predetermined power to cause recording material in the recording mark forming gas to accumulate and form recording marks, which have a different electrical resistance to the surface, at the first recording positions.

23. A data reproducing apparatus constructed to reproduce data from an information recording medium on which data has been recorded in accordance with the data recording method according to claim 1,
the data reproducing apparatus comprising:
a voltage applying unit that applies a voltage between a predetermined position on the information recording medium substrate and a position on the surface that differs to the predetermined position;
a current measuring unit that measures the current that flows between the predetermined position and the position on the surface; and
a control unit that controls the voltage applying unit and the current measuring unit,
wherein the control unit controls the voltage applying unit to apply the voltage and controls the current measuring unit to measure the current and reproduces the data based on the current measured at each position on the surface.

24. A data reproducing apparatus constructed to reproduce data from an information recording medium where data has been recorded on an information recording medium substrate in accordance with the data recording method according to claim 2,
the data reproducing apparatus comprising:
a distance measuring unit that measures the distance from a reference plane at each position on the surface of the information recording medium substrate;
a current measuring unit that applies a voltage between each position on the surface and a predetermined position on the information recording medium substrate that differs to the position on the surface and measures the current that flows between the predetermined position and the position on the surface; and
a control unit that controls the distance measuring unit and the current measuring unit,
wherein the control unit controls the distance measuring unit to carry out a distance measuring process to measure the distance from the reference plane at each position on the surface, controls the current measuring unit to carry out a current measuring process to measure the current at each position on the surface, and reproduces the data based on the distance and the current measured at each position.

25. An information recording medium on which data has been recorded by forming recording marks at the first recording positions in accordance with the data recording method according to claim 1.

26. An information recording medium according to claim 25 on which data has been recorded by forming concaves at second recording positions on the surface set corresponding to the content of the data and forming recording marks at the first recording positions.

27. An information recording medium according to claim 25, wherein the recording marks are formed with electrical resistances that correspond to the content of the data.

28. An information recording medium according to claim 26, wherein the recording marks are formed with electrical resistances that correspond to the content of the data.

29. An information recording medium according to claim 26, wherein the concaves are formed with depths that correspond to the content of the data.

30. An information recording medium according to claim 28, wherein the concaves are formed with depths that correspond to the content of the data.
